(19) United States
(12) Patent Application Publication
(10) Pub. No.: US 2014/0301030 A1
(43) Pub. Date: Oct. 9, 2014

(54) INDUSTRIAL COMPUTER STRUCTURE

(71) Applicant: AIC INC., Taoyuan Hsien (TW)

(72) Inventors: Lin-Kuei TSAI, Taoyuan Hsien (TW); Wei-Yuan LIU, Taoyuan Hsien (TW)

(73) Assignee: AIC INC., Taoyuan Hsien (TW)

(21) Appl. No.: 13/859,234

(22) Filed: Apr. 9, 2013

(51) Int. Cl. G06F 1/18

(52) U.S. Cl. CPC G06F 1/181; G06F 1/183
USPC 361/679.31; 361/679.4

(57) ABSTRACT

An industrial computer structure includes a case (100), a lug assembly (300), and touch panel (400). The case (100) has an opening (101) and a side plate (110) disposed on one side of the opening (101). The case (100) receives a plurality of trays (140) arranged within the opening (101). The side plate (110) has an external side (111) facing out of the case (100). The lug assembly (300) includes a fixing base (310) connected to the external side (111) of the side plate (110), a frame (320) disposed on the fixing base (310), and a handle (330) connected to the frame (320). The touch panel (400) is disposed in the frame (320) and electrically connected an electrical line (410) in the case (100). The components in the case (100) can be controlled via the touch panel (400) and thus the industrial computer can be easily maintained.

### BACKGROUND OF THE INVENTION

1. Field of the Invention

The present invention relates to a drawer type host and in particular to an industrial computer structure with a touch panel.

2. Description of Related Art

The drawer type host is usually applied to the server or industrial computers. It generally includes a case and is movably disposed in a large cabinet. A mother board and plural hard disks connected to the mother board are disposed in the case. In order to conveniently perform the simple setting of the mother board, a small screen and a simple keyboard are generally provided outside of the case for the operation and control of the mother board.

As for the related art structure of the drawer type host, only fixed commands can be given through the keyboard and it is thus only applicable to the mother boards of fixed type. Therefore, when the mother board in the case needs replacement, the keyboard has to be replaced accordingly.

In view of this, the inventor pays special attention to research with the application of related theory and tries to overcome the above disadvantages regarding the above related art, which becomes the goal of the inventor's improvement.

### SUMMARY OF THE INVENTION

An objective of the present invention is to provide an industrial computer structure with a touch panel.

To achieve the above objective, the present invention provides an industrial computer structure comprising a case, a lug assembly, and a touch panel. The case has an opening and a side plate disposed on one side of the opening. The case receives a plurality of trays which are arranged within the opening. The side plate has an external side facing out of the case. The lug assembly comprises a fixing base, a frame, and a handle. The fixing base is connected to the external side of the side plate. The frame is disposed on the fixing base. The handle is connected to the frame. The touch panel is disposed in the frame and is electrically connected to an electrical line extending into the case.

Preferably, in the above-mentioned industrial computer structure, an aperture is formed on the side plate, in which a side cover is disposed on the external side of the side plate, and the side cover covers the aperture.

Preferably, in the above-mentioned industrial computer structure, one end of the electrical line is clamped between the fixing base and the frame and is electrically connected to the touch panel, in which the electrical line extends between the side cover and the side plate.

Preferably, the above-mentioned industrial computer structure further comprises at least one storage medium which is disposed in one of the trays and is electrically connected to a primary circuit board.

Preferably, the above-mentioned industrial computer structure further comprises at least one secondary circuit board which is disposed in one of the trays and is electrically connected to a primary circuit board.

The industrial computer structure of the present invention controls the primary circuit board via a touch panel, which carries out easy maintenance and thus effectively overcomes the disadvantage of the related art.

### BRIEF DESCRIPTION OF DRAWING

FIG. 1 is a perspective view of the industrial computer structure according to one preferred embodiment of the present invention;

FIG. 2 is another perspective view of the industrial computer structure according to one preferred embodiment of the present invention from another view;

FIG. 3 is a perspective exploded view of the industrial computer structure according to one preferred embodiment of the present invention; and

FIG. 4 is a perspective exploded view of the industrial computer structure according to another preferred embodiment of the present invention.

### DETAILED DESCRIPTION OF THE INVENTION

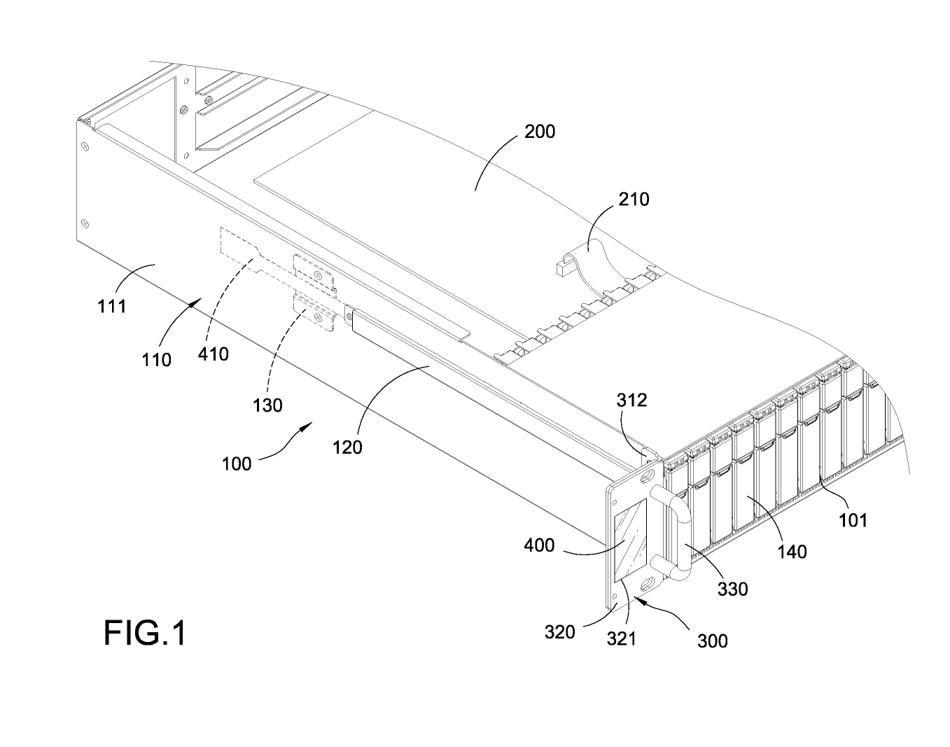

Please refer to FIG. 1. The preferred embodiment of the present invention provides an industrial computer structure comprising a case 100, a primary circuit board 200, a lug assembly 300, and a touch panel 400.

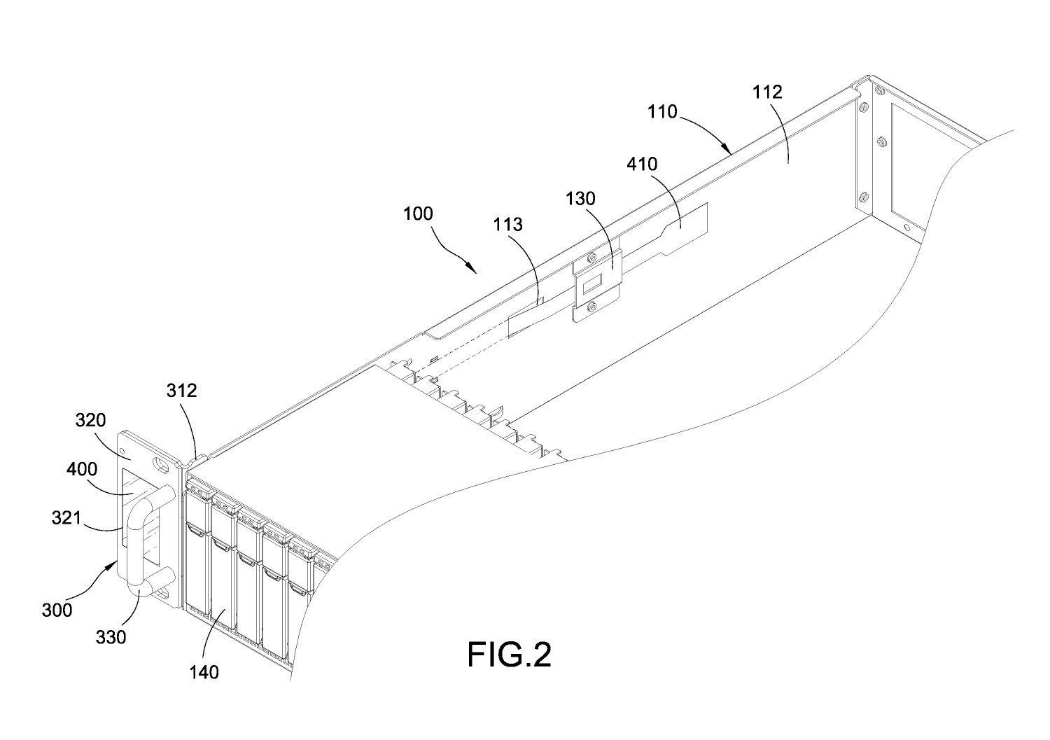

Please refer to FIGS. 1-3. The case 100 has a rectangular shape and preferably is made of metal plates. The case has an opening 101 and a side plate 110 disposed on one side of the opening 101. The side plate 110 has an external side 111 facing out of the case 100 and an internal side 112 facing the inside of the case 100; an aperture 113 is formed on the side plate 110. A side cover 120 is disposed on the external side 111 of the side plate 110 and the side cover 120 preferably covers the aperture 113; preferably, a clamp 130 is disposed on the internal side 112 of the side plate 110.

The case 100 receives a plurality of trays 140 and preferably the trays 140 are arranged within the opening 101. In the embodiment, each tray 140 is movably disposed within the opening 101 and can moved out of the case 100 through the opening 101 (but not limited to this in the present invention; for example, the trays 140 can be securely disposed within the opening 101). In the embodiment, a storage medium 141 may be swappable and disposed in one of the trays 140. The storage medium 141 may be a hard disk or a memory, but not limited to this.

The primary circuit board 200 is disposed in the case 100 and is electrically connected to the storage medium 141 in the respective tray 140. The primary circuit board 200 is preferably electrically connected to the storage medium 141 via a bus 210, but not limited to via the bus 210 in the present invention. Therefore, the primary circuit board 200 can access the data in the respective storage medium 141 via the bus 210.

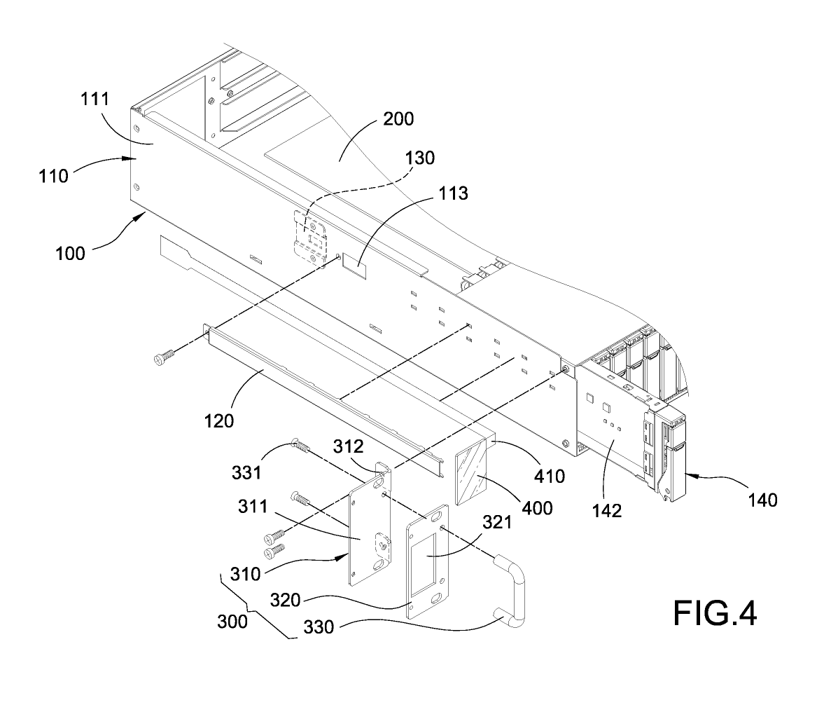

Also, please refer to FIG. 4. A secondary circuit board 142 may be disposed in the respective tray 140. The primary circuit board 200 is electrically connected to the secondary circuit board 142 in the respective tray 140. The primary circuit board 200 is preferably electrically connected to the respective tray 141 via the bus 210, but not limited to this in the present invention. Alternatively, the respective secondary circuit board 142 may be directly inserted into the primary circuit board 200.

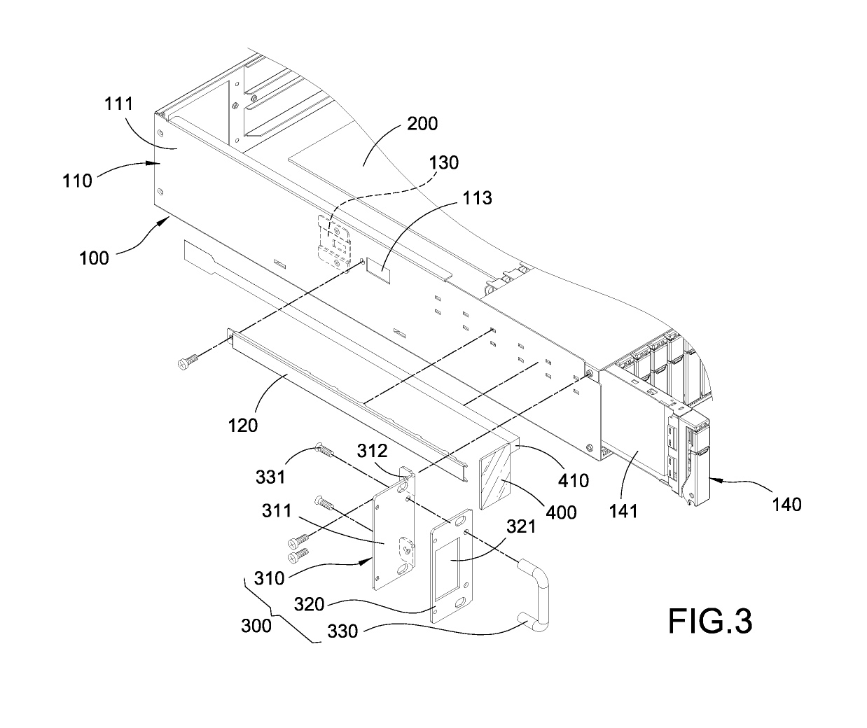

Please refer to FIG. 3. The lug assembly 300 is disposed on the external side 111 of the side plate 110. In the embodiment, the lug assembly 300 is preferably disposed next to the opening 101 of the side plate 110. The lug assembly 300 comprises a fixing base 310, a frame 320, and a handle 330. The fixing base 310 is preferably an L-shaped curved plate, which comprises a body 311 and a connection portion 312 disposed mutually vertically to the body 311. The connection portion 312 is preferably screwed to the external side 111 of the side plate 110; however, the fixing base 310 may comprise only a body 311 integrally formed with the side plate 110, but not limited to this in the present invention. The frame 320 is stacked on the body 311 of the fixing base 310. A window 321 is formed by cutting through the frame 320. Preferably, the window 321 is disposed and faces the same direction as the opening 101 of the side plate 110. In the embodiment, the handle 330 is screwed to and disposed on the frame 320 by means of screws 331; thus, when the industrial computer structure of the present invention is in the large cabinet, it can be pulled out of the large cabinet using the handle 330 for maintenance. The screws 331 are preferably penetrated through the body 311 and the frame 320; in this way, the frame 320 can be secured to the fixing base 310.

The touch panel 400 is a display with touch function and the display may be a TFT (Thin-Film Transistor) display, dot-matrix display or a character display; the present invention is not limited to the types of displays. The touch panel 400 is disposed in the window 321 of the frame 320 and the touch panel 400 is electrically connected to the primary circuit board 200 through an electrical line 410 running through the aperture 113 of the side plate 110. The electrical line 410 may be wire lines or FPC (Flexible Printed Circuit), but not limited to this in the present invention. The touch panel 400 may control the power supply through the primary circuit board 200 and may have an independent switch. In the embodiment, the touch panel 400 can be driven by the built-in circuit of the primary circuit board 200, or by an external circuit or an interface circuit added in the primary circuit board 200. One end of the electrical line 410 is clamped between the body 311 of the fixing base 310 and the frame 320 and is electrically connected to the touch panel 400. The electrical line 410 extends between the side cover 120 and the external side 111 of the side plate 110; also, the electrical line 410 extends through the aperture 113 into the case 100. Preferably, a part of the electrical line 410 can be secured between the clamp 130 and the internal side 112 of the side plate 110. Further, the other end of the electrical line 410 is electrically connected to the primary circuit board 200; in this way, the primary circuit board 200 can be operated and controlled through the touch panel 400.

The industrial computer structure of the present invention operates and controls the primary circuit board 200 through the touch panel 400. Therefore, different operating interfaces can be displayed on the touch panel 400, corresponding to different primary circuit boards 200. In addition, compared with the related art keyboard, the touch panel 400 can be connected to the primary circuit board 200 only through the electrical line 410, which is easier to install. As a result, compared with the related art, the industrial computer structure of the present invention can effectively reduce the maintenance cost of hardware equipment. Furthermore, the touch panel 400 in the present invention is disposed on the lug assembly 300, in which the components requiring manual operations are disposed concentratedly and thus facilitate the operation.

The above description is only about preferred embodiment of the present invention, but not to limit the scope of claims of the present invention. Other equivalent variations according to the claimed spirit of the present invention should be embraced within the claimed scope of the present invention.

What is claimed is:

1. An industrial computer structure, comprising:
a case (100) having an opening (101) and a side plate (110) disposed on one side of the opening (101), the case (101) receiving a plurality of trays (140) arranged within the opening (101), the side plate (110) having an external side (111) facing out of the case (100);
a lug assembly (300) comprising a fixing base (310) and a frame (320), the fixing base (310) being connected to the side plate (110), the frame (320) being disposed on the fixing base (310); and
a touch panel (400) disposed in the frame (320), the touch panel (400) being electrically connected to an electrical line (410) extending into the case (100).

2. The industrial computer structure according to claim 1, wherein an aperture (113) is formed on the side plate (110), and a side cover (120) is disposed on the external side (111) of the side plate (110) and the side cover (120) covers the aperture (113).

3. The industrial computer structure according to claim 2, wherein one end of the electrical line (410) is clamped between the fixing base (310) and the frame (320) and is electrically connected to the touch panel (400), and the electrical line (410) extends between the side cover (120) and the side plate (110).

4. The industrial computer structure according to claim 1, wherein an aperture (113) is formed on the side plate (110), and the electrical line (410) extends through the aperture (113) into the case (100).

5. The industrial computer structure according to claim 4, wherein the side plate (110) has an internal side (112) facing the inside of the case (100), wherein a clamp (130) is disposed on the internal side (112), wherein a port of the electrical line (410) is disposed between the clamp (130) and the internal side (112).

6. The industrial computer structure according to claim 4, wherein a side cover (120) is disposed on the external side (111) of the side plate (110) and the side cover (120) covers the aperture (113).

7. The industrial computer structure according to claim 6, wherein one end of the electrical line (410) is clamped between the fixing base (310) and the frame (320) and is electrically connected to the touch panel (400), and the electrical line (410) extends between the side cover (120) and the side plate (110).

8. The industrial computer structure according to claim 7, further comprising at least one storage medium (141) which is disposed in one of the trays (140).

9. The industrial computer structure according to claim 7, further comprising at least one secondary circuit board (142) which is disposed in one of the trays (140).

10. The industrial computer structure according to claim 5, wherein a side cover (120) is disposed on the external side (111) of the side plate (110) and the side cover (120) covers the aperture (113).

11. The industrial computer structure according to claim 10, wherein one end of the electrical line (410) is clamped between the fixing base (310) and the frame (320) and is electrically connected to the touch panel (400), and the electrical line (410) extends between the side cover (120) and the side plate (110).

12. The industrial computer structure according to claim 11, further comprising at least one storage medium (141) which is disposed in one of the trays (140).

13. The industrial computer structure according to claim 11, further comprising at least one secondary circuit board (142) which is disposed in one of the trays (140).

14. The industrial computer structure according to claim 1, wherein the lug assembly (300) comprises a handle (330) connected to the frame (320).
